(19) United States
(12) Patent Application Publication
(10) Pub. No.: US 2006/0200815 A1
(43) Pub. Date: Sep. 7, 2006

(54) Electronic Device and Method for Updating Related Programs

(76) Inventor: Wu-Cheng Li, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/164,858

(22) Filed: Dec. 8, 2005

(30) Foreign Application Priority Data
Dec. 8, 2004 (TW) 093138038

(51) Int. Cl. G06F 9/44

(52) U.S. Cl. 717/168

(57) ABSTRACT

An electronic device includes a memory and a program. The program includes a plurality of sub-modules, wherein each sub-module includes a plurality of stub functions and a plurality of functions, each stub-function corresponding to an address of a function respectively. The method for updating the program includes setting a plurality of stub-function in a first sub-module, and calling a first stub function in advance for getting an address of a first function when calling the first function. In the present invention, the time load of linking and down loading programs when updating programs is substantially reduced.

### BACKGROUND OF THE INVENTION

1. Field of the Invention

The present invention relates to an electronic device and a related method for updating a program, more particularly, to an electronic device and a related method for updating a program by assigning stub-functions for recording addresses of functions in a sub-module of the program, such that a sub-module of the program can be updated individually but does not need to be linked and downloaded with other sub-modules.

2. Description of the Prior Art

Generally speaking, programs adapted by electronic devices such as cell phones or other portable electronic devices usually include couples of sub-modules stored in different memory blocks separately, and each sub-module includes functions of different data lengths and different addresses of entry points in the programs. When there is a need to update some function of a sub-module of a program, the length of the program code of the updated function is probably changed. The change brings variations of entry points of other functions posterior to the updated function. Therefore, when calling functions of the updated sub-module during the execution of the program, a failure will occur due to linking to the wrong address if the original sub-module is simply be replaced by the updated sub-module.

Please refer to FIG. 1. FIG. 1 is a diagram illustrating a memory 100 of an electronic device in the prior art. Target image 110 is generated when the sub-modules are linked. The target image 110 includes N sub-modules, each of which is stored in a fixed area in the memory 100. The first sub-module 121 includes functions 1211, 1212 and 1213 stored in the memory 100 in sequence. Assume the addresses of the entry points of Function 1, Function 2 and Function 3 are 0x1100, 0x1200 and 0x1300 respectively, and the data lengths of Function 1 and Function 2 are both 0x100 bytes. Assume the data length of Function 1 is increased to 0x180 bytes when Function 1 is updated, hence the entry points of Function 2, Function 3 and following functions will all be affected in consequence. Please refer to FIG. 2. FIG. 2 is a diagram illustrating the updated sub-module 221 of the prior art. According to the above description, the data length of the updated Function 1 is increased to 0x180 bytes. Therefore the addresses of entry points of Function 2 and Function 3 are changed to 0x1280 and 0x1380, and the addresses of entry points of other following functions are changed in consequence. That is, in the prior art, though only program codes of the first function of the first sub-module are updated, the updated sub-module has to be re-linked with all other un-updated sub-modules in order to generate a new correct target image. The new target image then can be down loaded to the electronic device, and the program can then correctly link to correct entry points of called functions of the updated sub-module. Otherwise, when the program 110 calls Function 2, it calls Function 2 at the address 0x1200, while the entry point of Function 2 has been changed to 0x1280 due to the increase of the data length of Function 1. Therefore, the program 110 will not be able to find Function 2 at correct address and a failure will occur. For the reason above, in the prior art, the whole program needs to be re-linked and re-downloaded to the electronic device after any single bit of renovation. This is quite a burden to whether a common user or an professional engineer in design or test processes.

### SUMMARY OF THE INVENTION

It is therefore a primary objective of the claimed invention to provide an electronic device and related method for updating a program.

Briefly described, the claimed invention discloses a method for updating a program within an electronic device, wherein the program comprises a plurality of sub-modules. The method includes selecting a first sub-module, assigning a plurality of stub-functions corresponding to addresses of a plurality of functions in the first sub-module separately to the first sub-module, and getting an address of a first function by selecting a first stub-function among the plurality of stub-functions in advance, and executing the first function according to the address of the first function when calling the first function.

The claimed invention further discloses an electronic device. The electronic device includes a memory divided into a plurality of memory blocks, and a program having a plurality of sub-modules stored in the plurality of memory blocks correspondingly. Each sub-module has a plurality of functions and a plurality of stub-functions corresponding to addresses of the plurality of functions separately, wherein while calling the first function of the plurality of functions, an address of a first function is retrieved by selecting a first stub-function among the plurality of stub-functions, and the first function is executed according to the address.

It is an advantage of the present invention that the time load of linking and down loading updated programs is substantially reduced, which is a benefit to both users and designers of electronic devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory of an electronic device in the prior art.

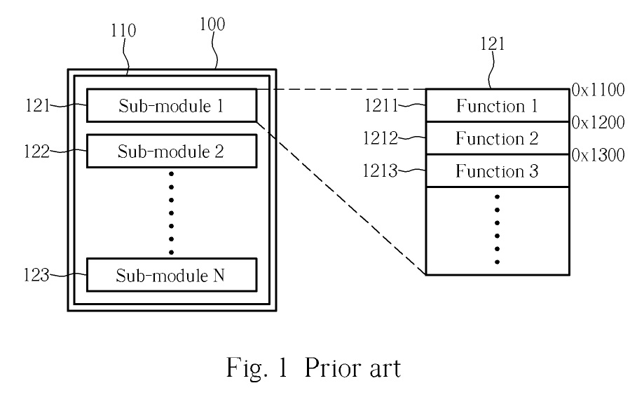

FIG. 2 is a diagram illustrating the updated sub-module of the prior art.

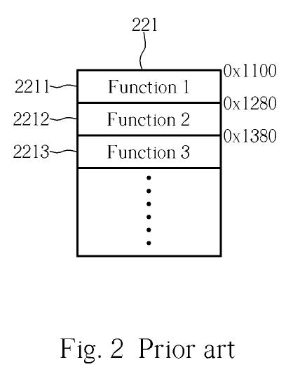

FIG. 3 is a diagram illustrating a memory of an electronic device of the present invention.

FIG. 4 is a diagram illustrating the first sub-module updated by the method of the present invention.

FIG. 5 shows a flow chart of the method for updating a program of the present invention.

### DETAILED DESCRIPTION

In the present invention, stub-functions are utilized in each sub-module to relate to the functions of the sub-module. When calling a function, the program of the present invention calls the corresponding stub-function of the function to be called in advance, and calls the function according to the address of the entry point of the function recorded in the corresponding stub-function afterward. The stub-functions are simply utilized to record the addresses of entry points of the corresponding function, and the data lengths are fixed. Therefore, the entry point of each stub-function is fixed no matter the content of the corresponding function is changed or the data length of the corresponding function is varied. In a consequence, when updating a part of the program, there is no need to re-link the whole program to generate a new target image, and it is not necessary to download the new target image to the electronic device. The time-load of linking and downloading is saved substantially. Hence the drawback of the prior art is released.

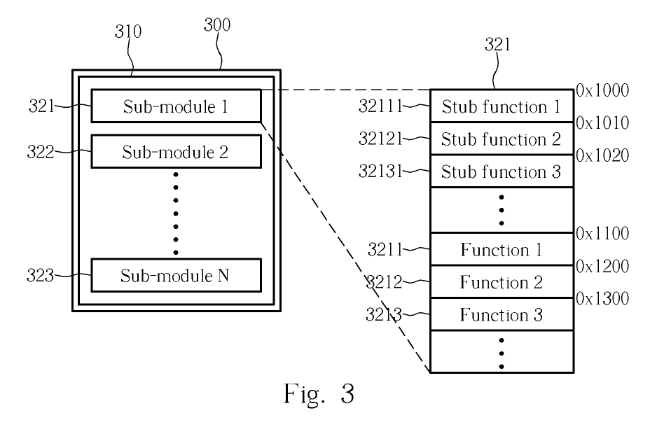

Please refer to FIG. 3. FIG. 3 is a diagram illustrating a memory 300 of an electronic device of the present invention. Target image 310 is generated when sub-modules of a program are linked. The target image 310 includes N sub-modules, each of which is stored in a fixed area in the memory 300 as in the prior art. The first sub-module 321 includes functions 3211, 3212 and 3213 and corresponding stub-functions 32111, 32121 and 32131 stored in the memory 300. As illustrated in FIG. 3, Stub-function 1, Stub-function 2 and Stub-function 3 are corresponding stub-functions of Function 1, Function 2 and Function 3 respectively, recording addresses of entry points of Function 1, Function 2 and Function 3. The addresses of entry points of Stub-function 1, Stub-function 2 and Stub-function 3 are 0x1000, 0x1010 and 0x1020 respectively, and addresses of entry points of Function 1, Function 2 and Function 3 are 0x1100, 0x1200 and 0x1300 respectively. In the method for updating programs of the claimed invention, when the program 300 needs to execute Function 2 of Sub-module 321, the corresponding Stub-function 2 is called first. The program 300 then calls Function 2 according to the address of entry point of Function 2 recorded in Stub-function 2. When updating Function 1 of Sub-module 321, assuming the data length of the updated Function 1 is increased to 0x180 bytes, the addresses of Function 2, Function 3 and following functions will be affected as well as in the prior art.

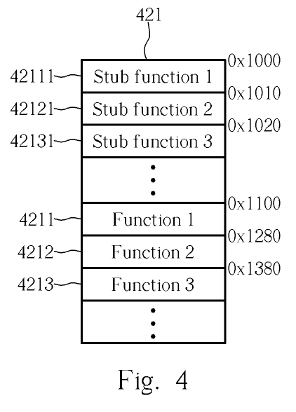

Please refer to FIG. 4. FIG. 4 is a diagram illustrating the first sub-module 421 updated by the method of the present invention. According to the above description, the data length of the updated Function 1 is increased to 0x180 bytes. Therefore the addresses of entry points of Function 2 and Function 3 are changed to 0x1280 and 0x1380, and the total data length of the first sub-module is changed accordingly. Addresses of entry points of other following functions are changed as well. However, in the present invention, the addresses of the entry points of Function 2 and Function 3 recorded in Stub-function 2 and Stub-function 3 are updated when Function 1 is updated and the first sub-module is re-linked. The data lengths of stub-functions are not changed because each stub-function is only for recording the address of the entry point of the corresponding function. That is, the address of the entry point of each stub-function is fixed. In the example shown in FIG. 4, the addresses of entry points of Stub-function 1, Stub-function 2 and Stub-function 3 are fixed at 0x1000, 0x1010 and 0x1020 respectively, which are the same as those of the stub-functions of the first sub-module 321 in FIG. 3. In the claimed invention, only the updated sub-module 421 has to be re-linked and downloaded to the memory 310 of the electronic device 300. There is no need to link the whole program, including those un-updated sub-modules, and it is not necessary to down load the whole program to the electronic device. When Function 2 of the first sub-module 421 is needed during execution of the program, Stub-function 2 is called at 0x1010 in advance. The updated address of entry point of Function 2, 0x1280, is retrieved in Stub-function 2, and hence Function 2 can be called at a correct address correctly. It shows that, the present invention utilizes stub-functions to record addresses of entry points of corresponding functions, wherein addresses of entry points of stub-functions are fixed. Therefore, stub-functions can always be linked successfully, and corresponding functions can be called correctly in consequence.

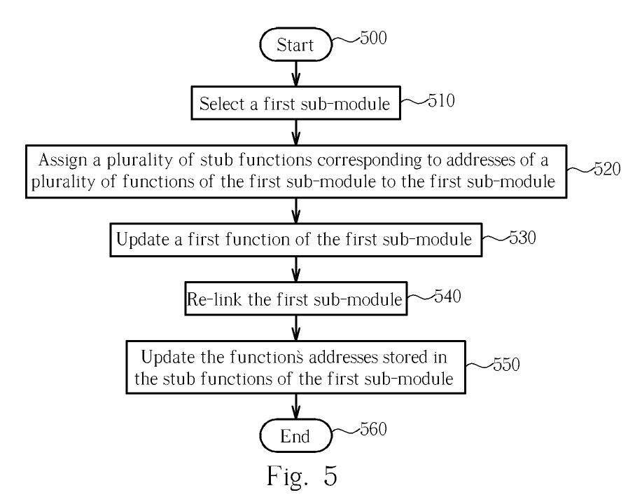

Please refer to FIG. 5. FIG. 5 shows a flow chart of the method for updating a program of the present invention.

Step 500: Start;

Step 510: Select a first sub-module comprising the function to update;

Step 520: Assign a plurality of stub-functions to the first sub-module, wherein the plurality of stub-functions are corresponding to addresses of a plurality of functions of the first sub-module;

Step 530: Update a first function of the first sub-module;

Step 540: Re-link the first sub-module;

Step 550: Update the functions' addresses stored in corresponding stub-functions of the first sub-module;

Step 560: End.

Step 550 is automatically executed when Step 540 re-links the first sub-module. Note that step 520 is especially for updating the claimed method on programs that are written in a conventional way (without stub-functions). The claimed method for updating programs further includes when executing a third sub-module of the program, calling the first function by the third sub-module.

The method for updating a program of the present invention utilizes a plurality of stub-functions in each sub-module for recording addresses of entry points of corresponding functions. The entry point and the data length of each stub-function is fixed, hence un-updated sub-modules do not need to be re-linked with the updated sub-module and do not need to be down loaded together with the updated sub-module. In the claimed invention, only the updated sub-module has to be re-linked for keeping track of the content of the stub-functions, that is, the addresses of the corresponding functions. The advance of the present invention is substantially saving the time load of linking and down loading programs when updating programs, such as updating the input program of an electronic device, adding a game program in a cell phone, replacing the screen driver of a cell phone, or updating the version of interface of an electronic device. Besides, the method of the present invention is compatible to recent conventional program codes. For example, when updating a conventional program, it is not necessary to assign corresponding stub-functions for functions in every sub-module. Only the codes for the sub-module to be updated needs to be re-write in a format according to the present invention. It is shown that the present invention improves the method of updating programs of electronic devices in a precise and effective way. The time-load of linking and down loading program codes is reduced substantially, which is a benefit to both users and researchers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for updating a program within an electronic device, wherein the program comprises a plurality of sub-modules, the method comprising:
selecting a first sub-module;
assigning a plurality of stub-functions to the first sub-module, wherein the plurality of stub-functions are corresponding to addresses of a plurality of functions in the first sub-module separately; and
when calling a first function, getting an address of the first function by selecting a first stub-function among the plurality of stub-functions in advance, and executing the first function according to the address of the first function.

2. The method of claim 1 wherein the electronic device comprises a memory for storing the program, the method further comprising:
storing the first sub-module in a first memory block of the memory, wherein the plurality of stub-functions are stored at fixed addresses of the first memory block.

3. The method of claim 2 wherein a size of the first memory block is fixed and is larger than a size of the first sub-module.

4. The method of claim 3 further comprising:
selecting a second sub-module for updating the first sub-module, wherein a size of the second sub-module is smaller than the first memory block;
replacing the first sub-module with the second sub-module; and
linking the second sub-module.

5. The method of claim 4 further comprising:
storing the plurality stub-functions of the second sub-module from a beginning of the first memory block.

6. The method of claim 2 storing the plurality of stub-functions from a beginning of the first memory block, and storing the plurality of functions after the plurality of stub-functions.

7. The method of claim 1 wherein the electronic device comprises a memory for storing the program, the method further comprising:
dividing the memory into a plurality of memory blocks; and
storing the plurality of sub-modules in the plurality of memory blocks correspondingly, wherein a size of each memory block is larger the a size of a corresponding sub-module.

8. The method of claim 1 further comprising:
assigning a plurality of stub-functions and a plurality of functions to a second sub-module, wherein the plurality of stub-functions are corresponding to addresses of the plurality of functions of the second sub-module separately; and
replacing the first sub-module with the second sub-module.

9. The method of claim 1 further comprising:
executing a third sub-module among a plurality of sub-modules, wherein the third sub-module calls the first function.

10. An electronic device comprising:
a memory divided into a plurality of memory blocks; and
a program having a plurality of sub-modules stored in the plurality of memory blocks correspondingly, in which each sub-module has a plurality of functions and a plurality of stub-functions corresponding to addresses of the plurality of functions separately; wherein while calling the first function of the plurality of functions, an address of a first function is retrieved by selecting a first stub-function among the plurality of stub-functions, and the first function is executed according to the address.

11. The electronic device of claim 10 wherein a first sub-module of the program is stored in a first memory block of the memory, and a plurality of stub-functions of the first sub-module are stored at fixed address of the first memory block.

12. The electronic device of claim 11 wherein a size of the first memory block is fixed and is larger than a size of the first sub-module.

13. The electronic device of claim 12 replacing the first sub-module with a second sub-module, wherein the second sub-module has a plurality of functions and a plurality of stub-functions corresponding to addresses of the plurality of functions of the second sub-module, and a size of the second sub-module is smaller than the first memory block.

14. The electronic device of claim 13 wherein the plurality of stub-functions of the second sub-module are stored from a beginning of the first memory block.

15. The electronic device of claim 11 wherein the plurality of stub-functions are stored from a beginning of the first memory block, and the plurality of functions are stored after the plurality of stub-functions.

16. The electronic device of claim 111 wherein a size of each memory block of the plurality of memory blocks is larger than a size of the corresponding sub-module.

17. The electronic device of claim 11 wherein a third sub-module of the plurality of sub-modules of the program is capable of calling the first function.
